(19) United States
(12) Patent Application Publication
(10) Pub. No.: US 2004/0102315 A1
(43) Pub. Date: May 27, 2004

(54) Reforming catalyst

(76) Inventors: Jillian Elaine Bailie, Berkshire (GB); David Wails, Berkshire (GB); Mark Robert Feaviour, Berkshire (GB); Suzanne Rose Ellis, Berkshire (GB)

Correspondence Address: RATNERPRESTIA, P O BOX 980, VALLEY FORGE, PA, 19482-0980, US

(21) Appl. No.: 10/305,693

(22) Filed: Nov. 27, 2002

(51) Int. Cl. B01J 21/08

(52) U.S. Cl. 502/304; 502/325

(57) ABSTRACT

A reforming catalyst comprising precious metal particles dispersed on a support material, wherein the precious metal particles comprise rhodium or ruthenium, characterised in that the support material comprises silica, alumina and ceria is disclosed. The catalyst shows improved sulphur tolerance. Catalysed components and fuel processing systems comprising the catalysts, and reforming processes using the catalysts are also disclosed.

The present invention relates to fuel reforming catalysts, catalysed components and fuel processing systems comprising the catalysts, and reforming processes using the catalysts.

Hydrogen is an important industrial gas and is used in a number of applications such as ammonia synthesis, methanol synthesis, chemical hydrogenations, metal manufacture, glass processing and fuel cells. Fuel processors produce hydrogen by reforming fuels such as methane, propane, methanol, ethanol, natural gas, liquefied petroleum gas (LPG), diesel and gasoline, and are used to provide hydrogen for a variety of applications, particularly for fuel cells. The reforming process produces a hydrogen-rich reformate stream that also comprises carbon dioxide, carbon monoxide and trace amounts of hydrocarbons or alcohols. Carbon monoxide is a severe poison for the catalysts in the anode of a fuel cell, so fuel processing systems generally comprise a fuel reformer and one or more carbon monoxide clean-up stages.

In a steam reforming process, water and fuel are combined to produce hydrogen and carbon dioxide, eg for methanol:

CH₃OH+H₂O→CO₂+3H₂

This process is endothermic, so steam reforming requires a continuous input of energy. In an autothermal reforming process, both water and air are mixed with the fuel. The process combines steam reforming and partial oxidation, eg for methanol:

CH₃OH+H₂O→CO₂+3H₂

CH₃OH+½O₂→CO₂₊2H₂

The partial oxidation is exothermic, thus providing the heat for the endothermic steam reforming reaction. Another reaction which may take place within the autothermal reformer is the water gas shift reaction:

CO+H₂O→CO₂+H₂

This is a particularly useful reaction because it reduces CO content and increases hydrogen content. Autothermal reforming processes are described in WO 96/00186.

Catalysts are used to promote the various reforming reactions. Generally the catalysts comprise metal particles deposited on ceramic support materials. A commonly used support material is γ-Al₂O₃ due to its mechanical stability, moderately high surface area, resistance to sintering over a wide range of temperatures and high degree of metal dispersion that can be achieved. EP 1 157 968 discloses a catalyst for use in autothermal reforming reactions which contains rhodium and optionally platinum on an active aluminium oxide.

Desirably the catalysts promote the reforming reactions over a wide temperature range and for a variety of fuels. The catalyst should be durable, ie the performance should not decrease significantly with time. One factor that can decrease catalyst performance and durability is the presence of sulphur within fuels. Fuels such as gasoline, diesel and natural gas contain levels of sulphur up to 150 ppm and this is a poison for many state-of-the-art reforming catalysts. Another factor that can decrease catalyst performance is deposition of carbon particles onto the catalyst.

To avoid sulphur poisoning, the sulphur can be removed from a fuel before it is added to a fuel processing system, but this will significantly increase the cost of the fuel. Alternatively a fuel processing system can comprise a desulphurisation unit, which contains a sulphur trap material. The unit may be located before or after the reformer, or before or between the CO clean-up units. However, the inclusion of a desulphurisation unit increases the complexity, size and cost of the fuel processing system. Another approach is to periodically replace or regenerate catalysts that have been poisoned by sulphur. This can interrupt hydrogen generation and the replacement of catalysts may be costly. A preferred approach is to develop catalysts that are intrinsically sulphur tolerant and are not poisoned by the amounts of sulphur commonly found in fuels such as gasoline. It is an object of the present invention to provide a reforming catalyst with improved sulphur tolerance. The catalyst should also demonstrate high performance and durability. It is a further object of the present invention to provide a reforming catalyst wherein carbon deposition is decreased.

Accordingly the present invention provides a reforming catalyst comprising precious metal particles dispersed on a support material, wherein the precious metal particles comprise rhodium or ruthenium, characterised in that the support material comprises silica, alumina and ceria.

The present inventors have found that the catalysts according to the invention show improved sulphur tolerance and decreased carbon deposition.

The weight ratio of silica:alumina in the support material is suitably between 1:100 and 100:1, preferably between 5:100 and 1:1. Suitably the support material comprises ceria dispersed on the surface of a silica-alumina material. The silica-alumina material may contain regions of silica, regions of alumina and/or regions of mixed silicon/aluminium oxide. The silica-alumina material may contain other components, but preferably contains only silica, alumina and mixed silicon/aluminium oxide. In a preferred embodiment, the surface of the silica-alumina material is silica rich and the centre of the silica-alumina material is alumina rich. Suitable silica-alumina materials and their manufacture are described in U.S. Pat. No. 5,045,519 and are available from Sasol GmbH (Brunsbuettel, Germany). The surface area of the silica-alumina material is suitably above 100 m²/g, preferably above 150 m²/g, most preferably above 200 m²/g.

Preferably the support material further comprises zirconia, and the zirconia is suitably dispersed, with ceria, on the surface of a silica-alumina material. The loading of ceria or ceria and zirconia is suitably 10-60 wt % based on the weight of the support material. The ceria and zirconia may be present as regions of ceria, regions of zirconia and/or regions of mixed ceria-zirconia oxide. It is preferred that the majority of the ceria and zirconia is present as the mixed oxide. The atomic ratio of ceria:zirconia is suitably in the range from 10:1 to 1:10, preferably from 5:1 to 1:1. The average particle size of the ceria and zirconia particles on the surface of the silica-alumina material is suitably below 15 nm, preferably below 8 nm.

The precious metal particles comprise rhodium or ruthenium. The precious metal particles may be rhodium or ruthenium alone, or may be alloy particles comprising rhodium and/or ruthenium. Suitable alloying metals include other precious metals such as platinum, palladium, osmium or iridium, preferably platinum, but may also include base metals. In a preferred embodiment the precious metal particles are rhodium particles or platinum-rhodium alloy particles. In a particularly preferred embodiment the precious metal particles are rhodium particles.

The precious metal particles are dispersed on the support material. When the support material comprises ceria and zirconia dispersed on a silica-alumina material, the precious metal particles may be deposited on the silica-alumina material, on the ceria-zirconia particles and/or at the interfaces of the ceria-zirconia and the silica-alumina. Suitably the loading of the precious metal particles is 0.5-10 weight %, based on the weight of the support material. If the precious metal particles are platinum-rhodium alloy particles, a suitable atomic ratio of platinum:rhodium is between 5:1 and 1:5, preferably about 1:1.

In a preferred embodiment, the reforming catalyst further comprises an alkali metal or alkaline earth metal promoter, preferably lithium. The promoter is deposited on the surface of the support material and is preferably alloyed with the precious metal particles. The atomic ratio of precious metal particles to promoter material is suitably between 20:1 and 5:1.

The catalyst may be prepared by any suitable methods known to those skilled in the art. Suitable methods include co-impregnation, deposition precipitation and co-precipitation procedures.

A suitable method for preparing the support material is the deposition of ceria and optionally zirconia onto a silica-alumina material by a sol-gel route. The method uses sols of ceria and zirconia, which are stabilised by counter ions such as nitrate and acetate. Suitable sols are available from Nyacol Nano Technologies Inc. (Ashland, Mass., USA). The counter ion to metal ratio is suitably in the range from 0.1:1 to 2:1. The metal oxide content is suitably between 100 and 500 g/l and the average particle size is suitably from 1-100 nm. The sols are added to a slurry of a silica-alumina support material. A base such as 1M ammonia solution is added to the slurry. The product is then washed several times, dried, eg at 120° C. and calcined, eg at 800° C.

A suitable method for the deposition of the precious metal particles onto the support material is co-impregnation. Suitable metal salts are made up into a solution such that the volume of solution is sufficient to fill the entire pore volume of the support material. The solution is added to the support material, the material is mixed thoroughly and then dried and calcined. An alternative, but lengthier, method is to sequentially impregnate the different metal species.

Another suitable method for the deposition of the precious metal particles is co-deposition. The support material is dispersed in a slurry containing suitable precious metal salts. A base is added to deposit the metal onto the support material, and the catalyst is dried and calcined.

In a further aspect, the present invention provides a catalysed component comprising the reforming catalyst according to the invention. The catalysed component comprises the reforming catalyst deposited on a suitable substrate. The substrate may be any suitable flow-through substrate such as a monolith, foam, static mixer or heat exchanger unit. Alternatively the substrate may comprise discrete units such as pellets, rings etc. which are enclosed in a container. The substrate may be ceramic, eg cordierite, or metallic. The amount of catalyst on the substrate is suitably from 0.5-5 g/in³ (0.03-0.3 g/cm³).

The catalyst is deposited on the substrate using any appropriate techniques known to those skilled in the art. Suitably, the catalyst is dispersed in water, possibly with additional binders, thickeners or adhesive agents to form a slurry. It is usually necessary to break down the particle size of the catalyst by milling the slurry, eg in a ball mill or a bead mill, or by milling the dry catalyst before it is added to the slurry, eg in a jet mill. The slurry is passed over or through the substrate to coat the surfaces that will be exposed to the reactant gases. This can be done by dip coating, flood coating or waterfall coating. These and other methods, such as vacuum impregnation, are well known in the art. Any excess slurry is removed, and the substrate is subsequently dried and calcined.

In a yet further aspect, the present invention provides a process for reforming fuel using a catalysed component according to the invention. The process comprises the step of supplying fuel, steam and optionally air to the catalysed component. The fuel may comprise up to 150 ppm sulphur. The fuel may be an alkane such as methane, an alcohol such as methanol or a mixture of components, such as gasoline. Liquid fuels must be vaporised before they are supplied to the catalysed component. If the process uses steam reforming (and not autothermal reforming), heat must be supplied to the reaction or to the catalysed component, eg by pre-heating the fuel and/or steam.

In a yet further aspect, the present invention provides a fuel processing system comprising a catalysed component according to the invention. The system may further comprise carbon monoxide clean-up components (eg water gas shift reactors, selective oxidation reactors, hydrogen diffusion membranes), heat exchanger components and catalytic burners.

The invention will now be described by reference to examples which are not meant to be limiting thereof.

Catalyst Manufacture

Three different catalysts were prepared:

| | Support | Catalytic metal |
|---|---|---|
| Comparative | 30 wt % ceria and zirconia on | 2 wt % rhodium |
| Catalyst 1 | alumina (SCF-140) | Lithium promoter (Rh:Li |
| | | molar ratio of 10:1) |
| Catalyst 1 | 30 wt % ceria and zirconia on | 2 wt % rhodium |
| | silica-alumina (Siralox | Lithium promoter (Rh:Li |
| | 10/360) | molar ratio of 10:1) |
| Catalyst 2 | 40 wt % ceria and zirconia on | 2 wt % rhodium |
| | silica-alumina (Siralox | Lithium promoter (Rh:Li |
| | 10/360) | molar ratio of 10:1) |

The alumina and the silica-alumina were purchased from Sasol GmbH (Brunsbuettel, Germany). The alumina or silica-alumina materials were slurried in demineralised water, and nitrate-stabilised ceria and zirconia sols were added. Ammonia solution (IM) was added until the pH of the slurry reached 8. The product was filtered and washed several times to remove NH₄NO₃ and then dried at 120° C. for 8 hours and calcined at 800° C. for 2 hours.

A co-impregnation method was used to deposit the rhodium and lithium onto the support material. Rhodium nitrate (Johnson Matthey, UK) and lithium nitrate (BDH, AnalaR® grade) were made up into an aqueous solution such that the volume of solution was sufficient to fill the entire pore volume of the support material. The solution was added to the support material, the material was mixed and then the material was dried at 120° C. for 8 hours and calcined at 500° C. for 2 hours.

Catalysed Component Manufacture

The catalysts were deposited onto cordierite monoliths with cell densities of 900 cells per square inch (equivalent to 140 cells per square centimetre) and 1200 cpsi (186 cells per cm²) using the following general method:

The catalyst was dispersed in water, providing a slurry with a solid content of about 35 wt %. A hydroxyethylcellulose thickener (Natrosol, Hercules) was added to the slurry at a loading of 0.05 wt % with respect to the weight of the slurry. The slurry was mixed using a Silverson mixer, and milled using a bead mill.

The slurry was applied to the monoliths using a vacuum impregnation process. The slurry was applied to one of the open surfaces of the monolith, and a vacuum was applied to draw the slurry into the monolith. The monolith was dried and then slurry was applied to the second open surface of the monolith, using the same method. The monolith was dried at 120° C. and subsequently calcined at 500° C. for 4 hours.

The loading of catalyst on each monolith was 2 g/in³ (0.12 g/cm³).

Performance Tests

A pre-heated mix of steam, fuel and air was passed over the catalysed components and the product stream was dried using condensers and a Signal drier unit before analysis by a micro-gas chromatograph. The non-methane hydrocarbon (NMHC) level was measured as an indication of how effectively the catalysed component has reformed the fuel. A low level of NMHC indicates high conversion and an effective catalyst.

Test 1: Sulphur Tolerance

Two catalysed components were tested. Comparative Example 1 was a 900 cpsi cordierite monolith coated with comparative catalyst 1 at a loading of 2 g/in³. Example 1 was a 900 cpsi cordierite monolith coated with catalyst 1 at a loading of 2 g/in³. The monoliths were cored to give cylindrical catalysed components of length 3 in (7.5 cm) and diameter 1.4 in (3.5 cm).

The pre-heated mix of steam, fuel and air was passed over the catalysed components at a gas hourly space velocity of 75000 h⁻¹. The ratio of the gases was O₂:C=0.4 and H₂O:C=2 (where C is moles of carbon, not moles of fuel). The pressure was 1 bara (1 bar absolute), ie atmospheric pressure. The temperature at the gas outlet was ramped from 700° C. to 730° C. to 760° C. during the course of the six hour test. The fuel was a complex mix gasoline comprising 10 ppm sulphur.

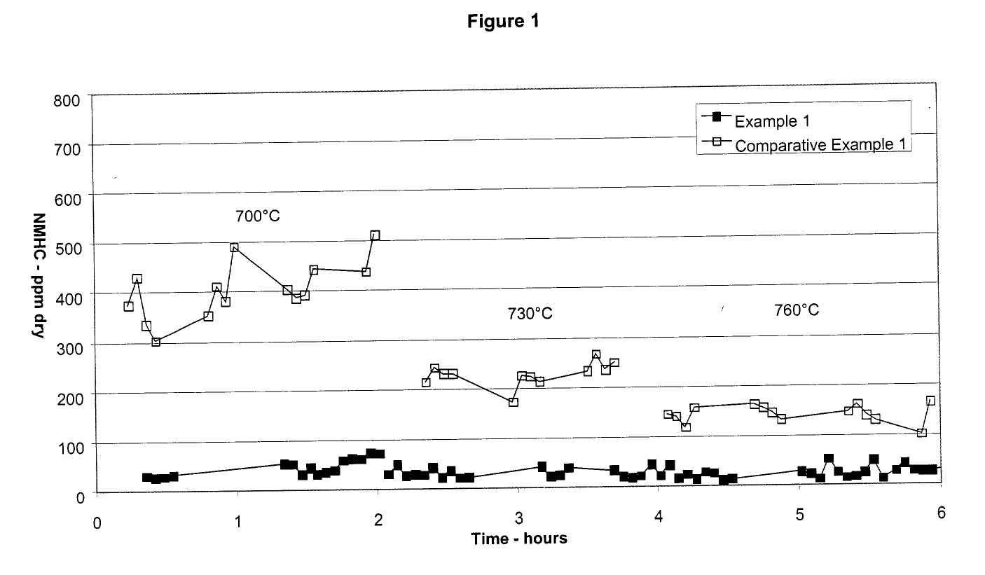

FIG. 1 shows the NMHC levels for comparative example 1 and example 1. It is clear that the catalyst according to the invention performs significantly better across the temperature range than the catalyst based on a ceria/zirconia/alumina support, indicating improved sulphur tolerance.

Test 2: Sulphur Tolerance

Three catalysed components, examples 2, 3 and 4, were tested. Examples 2, 3 and 4 were 900 cpsi cordierite monoliths coated with catalyst 1 at a loading of 2 g/in³. The monoliths were cored to give cylindrical catalysed components of length 3 in (7.5 cm) and diameter 1.4 in (3.5 cm).

The tests were run under the same conditions as for Test 1 except that different fuels were used. Example 2 was tested using simple gasoline-like fuel (having similar physical properties to commercial gasoline, eg density, octane number) with 0 ppm sulphur. Example 3 was tested using complex mix gasoline with 10 ppm sulphur (as used in Test 1). Example 4 was tested using commercial gasoline with 100 ppm sulphur.

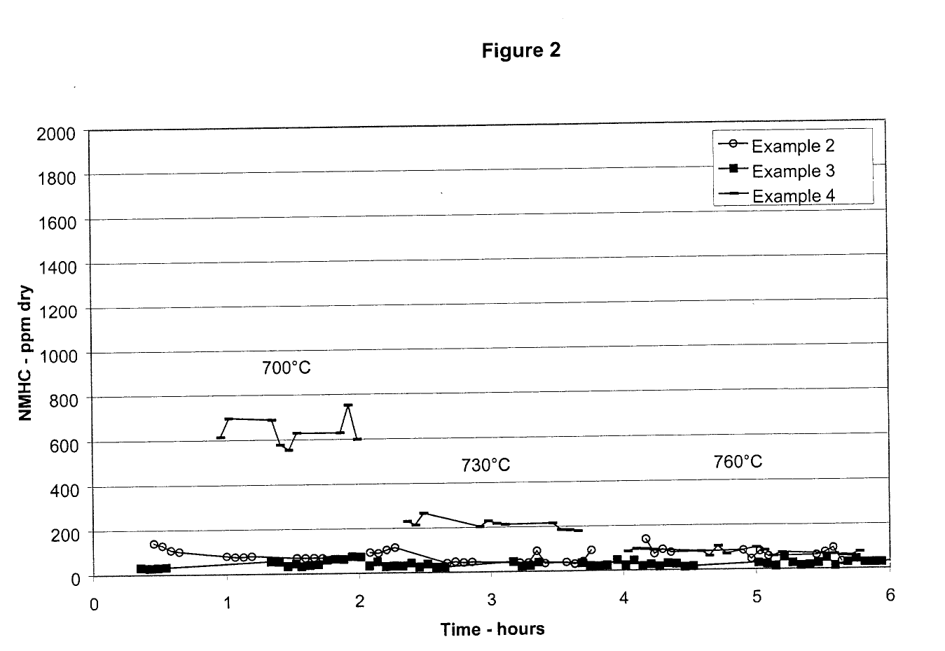

FIG. 2 shows the NMHC levels for examples 2, 3 and 4. The results show that a sulphur level of 10 ppm has no affect on the catalyst according to the invention (the performance for example 3 is equivalent to the performance for example 2). A sulphur level of 100 ppm does cause a performance decrease at low temperature (700° C.), but overall the NMHC level is still low for such a high level of sulphur.

Test 3: Durability

Three catalysed components were tested. Comparative example 2 was a 1200 cpsi cordierite monolith coated with comparative catalyst 1 at a loading of 2 g/in³. Example 5 was a 1200 cpsi cordierite monolith coated with catalyst 1 at a loading of 2 g/in³. Example 6 was a 1200 cpsi cordierite monolith coated with catalyst 2 at a loading of 2 g/in³. The monoliths were cored to give cylindrical catalysed components of length 3 in (7.5 cm) and diameter 1.4 in (3.5 cm).

The pre-heated mix of steam, fuel and air was passed over the catalysed components at a gas hourly space velocity of 139000 h⁻¹. The ratio of the gases was O₂:C=0.375 and H₂O:C=2.5. The pressure was 2 bara. The temperature at the gas inlet was 450° C. throughout the 120 hour test. The fuel was a simple gasoline-like fuel containing 0 ppm sulphur.

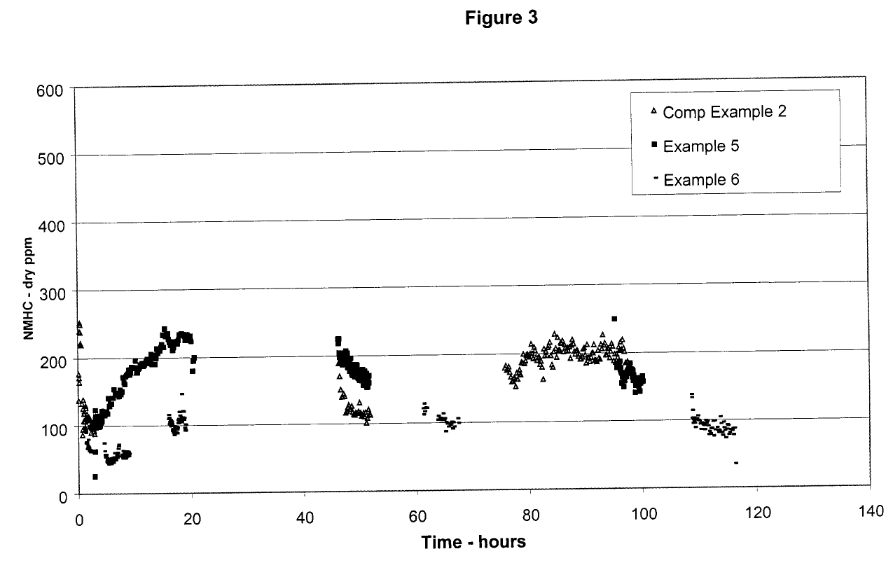

FIG. 3 shows the NMHC levels for comparative example 2, and examples 5 and 6. The results show that the catalysts according to the invention and the comparative catalyst have comparable durability, with the catalyst performance remaining roughly constant during the test. This durability test was run in the absence of sulphur.

Test 4: Carbon Deposition

Two catalysed components were tested. Comparative example 3 was a 900 cpsi cordierite monolith coated with comparative catalyst 1 at a loading of 2 g/in³. Example 7 was a 1200 cpsi cordierite monolith coated with catalyst 1 at a loading of 2 g/in³. The monoliths were cored to give cylindrical catalysed components of length 3 in (7.5 cm) and diameter 1.4 in (3.5 cm).

The pre-heated mix of steam, fuel and air was passed over the catalysed components at a gas hourly space velocity of 75000 h⁻¹. The ratio of the gases was O₂:C=0.40 and H₂O:C=0.2. The pressure was 1 bara. The temperature at the gas outlet was 650° C. throughout the 7 hour test. The fuel was a simple gasoline-like fuel containing 0 ppm sulphur.

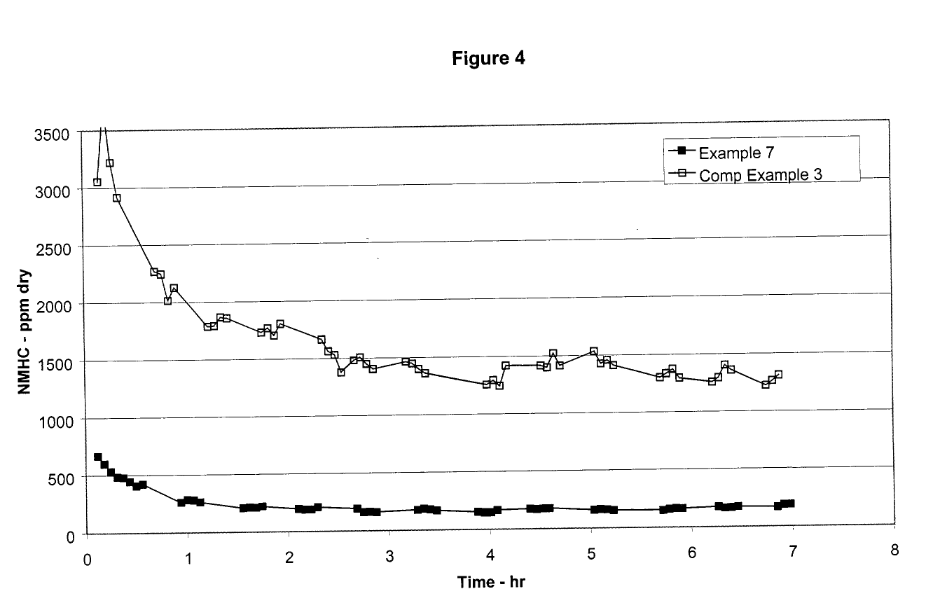

FIG. 4 shows the NMHC levels for comparative example 3, and example 7. The catalyst according to the invention has significantly better performance than the comparative catalyst at 650° C. One possible explanation for the improved performance is that the catalyst according to the invention is less susceptible to carbon deposition (which is usually more extensive at 650° C. than at the temperatures employed in tests 1-3).

1. A reforming catalyst comprising precious metal particles dispersed on a support material, wherein the precious metal particles comprise at least one of rhodium or ruthenium and the support material comprises silica, alumina and ceria.

2. A reforming catalyst according to claim 1, wherein the support material comprises ceria dispersed on the surface of a silica-alumina material.

3. A reforming catalyst according to claim 2, wherein the surface area of the silica-alumina material is above 100 m²/g.

4. A reforming catalyst according to claim 1, wherein the weight ratio of silica to alumina is between 5:100 and 1:1.

5. A reforming catalyst according to claim 1, wherein the support material further comprises zirconia.

6. A reforming catalyst according to claim 2, wherein the support material further comprises zirconia, which is dispersed, with the ceria, on the surface of the silica-alumina material.

7. A reforming catalyst according to claim 1, wherein the loading of ceria or ceria and zirconia is 10-60 wt % based on the weight of the support material.

8. A reforming catalyst according to claim 1, wherein the precious metal particles are rhodium particles or platinum-rhodium alloy particles.

9. A reforming catalyst according to claim 8, wherein the precious metal particles are rhodium particles.

10. A reforming catalyst according to claim 1, wherein the loading of the precious metal particles is 0.5-10 weight %, based on the weight of the support material.

11. A reforming catalyst according to claim 1, further comprising an alkali metal or alkaline earth metal promoter.

12. A reforming catalyst according to claim 11, wherein the promoter is lithium.

13. A catalysed component comprising a substrate and a reforming catalyst, deposited on the substrate, and comprising precious metal particles dispersed on a support material, wherein the precious metal particles comprise at least one of rhodium or ruthenium and the support material comprises silica, alumina and ceria.

14. A catalysed component according to claim 13, wherein the substrate is a monolith, foam, static mixer or heat exchanger unit.

15. A catalysed component according to claim 13, wherein the substrate is ceramic.

16. A catalysed component according to claim 13, wherein the substrate is metallic.

17. A catalysed component according to claim 13, wherein the amount of catalyst on the support is from 0.5-5 g/in³ (0.03-0.3 g/cm³).

18. A process for reforming fuel comprising the step of supplying fuel, steam and optionally air to a catalysed component comprising a substrate and a reforming catalyst, deposited on the substrate, and comprising precious metal particles dispersed on a support material, wherein the precious metal particles comprise at least one of rhodium or ruthenium and the support material comprises silica, alumina and ceria.

19. A fuel processing system comprising a catalysed component according to claim 13.
